(19) United States
(12) Patent Application Publication
(10) Pub. No.: US 2012/0231411 A1
(43) Pub. Date: Sep. 13, 2012

(54) DENTAL PROBE WITH CURETTE

(75) Inventor: Jacques Verronneau, St-Hyacinthe (CA)

(73) Assignee: The Royal Institution For The Advancement of Learning / McGill University, Montreal (CA)

(21) Appl. No.: 13/502,666

(22) PCT Filed: Oct. 19, 2010
(86) PCT No.: PCT/CA10/01642

§ 371 Date: Jun. 1, 2012

Related U.S. Application Data
(60) Provisional application No. 61/252,833, filed on Oct. 19, 2009.

(51) Int. Cl. A61C 17/00; A61C 19/04

(52) U.S. Cl. 433/75; 433/143

(57) ABSTRACT

There is described a hand-held dental instrument for detection of carious lesions which includes a handle portion defining a longitudinal axis therethrough and at least a first working end, mounted on the handle portion, which includes a probe body extending from the handle portion and a probe tip disposed at a remote end. The probe tip is configured for exploring teeth and/or periodontal pockets. The probe body is curved and has a curette portion disposed on the probe body between the handle portion and the probe tip, the curette portion having at least two scraping fins each defining a curved blade for removing at least one of biofilm, plaque and tartar from a curved tooth surface.

### CROSS REFERENCE TO RELATED APPLICATIONS

This application is a National Stage Entry of PCT Application Serial No. PCT/CA2010/001642 having an international application date of Oct. 19, 2010, which application claims priority from U.S. Provisional Application Ser. No. 61/252,833, filed Oct. 19, 2009; the disclosures of which are incorporated herein by reference.

### TECHNICAL FIELD

The present application relates generally to dental instruments, and more particularly to hand-held dental probes and explorers.

### BACKGROUND

Dental caries is a dieto-bacterial disease that occurs as an interaction between biofilm or dental plaque and a tooth surface and subsurface. Clinical manifestations or disease symptoms are the result of mineral loss caused by lowering of the pH on the tooth surface and active bacteria in the dental plaque. Dental caries is largely preventable or manageable if an early detection of carious lesions is performed. This concept stimulated the emergence of clinical caries indexes which take into account the lesion activity and detailed depth associated with lesion progression. Modern development allows for a better patient treatment outcome and monitoring in time with increased prevention opportunities. However, no single dental instrument specific for all of these applications has been developed.

Biofilm retention is seen as a prerequisite for lesion initiation and progression. Traditional sites associated with dental plaque accumulation are: pits and fissures in occlusal surfaces, approximal surfaces cervical to a contact point or area and buccal/lingual surfaces of posterior premolar and molars along the gingival margin.

During a dental examination, a dentist or a technician such as a dental hygienist explores the teeth of a patient using a dental instrument such as a dental explorer and/or a periodontal probe. The resistance encountered by the dental instrument (tactile perception) while examining a tooth may indicate the state of the tooth. However, before examining surfaces of the tooth the dentist or technician has to remove the biofilm or plaque deposited on the tooth which can hide initial stages of cavities or the like. The removal of the biofilm or plaque is usually performed using a periodontal curette in a separate procedure prior to the actual dental examination using either a dental explorer or a periodontal probe.

The usual removal of the biofilm or plaque and the exploration of carious lesions on tooth surfaces involves the use of two different instruments, namely a periodontal curette for removing the plaque and a dental instrument, such as a periodontal probe and/or a dental explorer, for lesion detection. This forces the dentist to work with each instrument serially (i.e. one instrument at a time) dividing his attention between the use of the two or more instruments. However, during the examination, the dentist often requires a free hand to position a mirror for example. In this case, the dentist can only use either the dental sensor or the periodontal curette simultaneously with the mirror. As a result, the consecutive use of different instruments increases the overall examination time and associated cost.

Additionally, due to a lack of standardization in the field of dental instruments, most dentists use conventional dental explorers which are not adapted for optimal carious lesion activity detection and depth detection. Modern systems for early clinical detection use two carious lesions detection instruments, i.e. a gentle dental explorer adapted to assess cavitation and lesion activity and a periodontal probe for lesion depth assessment. However, these two carious lesions detection instruments are respectively used by trained dentists in different jurisdictions. For example, most European expert dentists use a relatively sharp dental explorer and most North American expert dentists use a periodontal probe capable of deepness assessment and dental lesion detection.

Therefore, there is a need for an improved dental instrument which addresses at least some of these deficiencies.

### SUMMARY

According to a first broad aspect, there is provided a hand-held dental instrument for detection of carious lesions comprising: a handle portion adapted to be grasped by a hand of a user and defining a longitudinal axis extending axially therethrough; and at least a first working end mounted on the handle portion, the first working end including a probe body extending from the handle portion and a probe tip disposed at a remote end of the probe body, the probe tip being configured for exploring at least one of teeth and periodontal pockets, the probe body being curved and defining a curette portion thereon between the handle portion and the probe tip, the curette portion having at least two scraping fins projecting radially from the probe body in opposite directions, the scraping fins each defining a curved blade for removing at least one of biofilm, plaque and tartar from a curved tooth surface.

According to a second broad aspect, there is provided a hand-held dental instrument for detection of carious lesions and including a handle portion defining a longitudinal axis therethrough, the hand-held dental instrument comprising: a first working end mounted on the handle portion at one end thereof, the first working end including a first probe body extending from the handle portion and a sharp dental explorer tip disposed at a remote end of the first probe body, the sharp dental explorer tip being configured for determining a presence of tooth decay on a tooth surface, and a first curette portion disposed on the first probe body between the handle portion and the sharp dental explorer tip; and a second working end mounted on the handle portion at another end thereof, the second working end including a second probe body extending from the handle portion and a periodontal explorer tip disposed at a remote end of the second probe body, the periodontal explorer tip being configured for exploring periodontal pockets, and a second curette portion disposed on the second probe body between the handle portion and the periodontal probe tip.

The expression “dental explorer” and “dental explorer end” refers to an instrument or an end of an instrument comprising a substantially sharp point at an extremity thereof for determining the presence of tooth decay on a tooth surface.

The expression “periodontal probe” and “periodontal probe end” refers to an instrument or an end of an instrument adapted to measure pocket depths around a tooth. In some instances, a “periodontal probe” and “periodontal probe end” may also be adapted and/or used to determine the presence of tooth decay on a tooth surface.

### BRIEF DESCRIPTION OF THE DRAWINGS

Further features and advantages of the present invention will become apparent from the following detailed description, taken in combination with the appended drawings, in which:

FIG. 1A illustrates a front view of a dental instrument provided with a periodontal probe tip, in accordance with a first embodiment;

FIG. 1B is a side view of the dental instrument of FIG. 1A;

FIG. 2A illustrates a scraping fin having a square edge;

FIG. 2B illustrates a scraping fin having a beveled edge;

FIG. 2C illustrates a scraping fin having a trapezoidal edge;

FIG. 3A is a front view of a dental instrument provided with a periodontal probe tip and a dental explorer tip, in accordance with another embodiment;

FIG. 3B is a side view of the dental instrument of FIG. 3A;

FIG. 4 is a front view of a dental instrument provided with a periodontal probe tip and a dental explorer tip, in accordance with a further embodiment;

FIG. 5 is a side view of the dental instrument of FIG. 4;

FIG. 6 is a side view of the dental explorer tip of the dental instrument of FIG. 4;

FIG. 7 is a top view of the dental explorer tip of the dental instrument of FIG. 4;

FIG. 8 is a side view of the periodontal probe tip of the dental instrument of FIG. 4;

FIG. 9 is a top view of the periodontal probe tip of the dental instrument of FIG. 4;

FIG. 10 is a side view of an extremity of the periodontal probe tip of the dental instrument of FIG. 4; and

FIG. 11 is a photograph illustrating a use of a dental instrument, in accordance with an embodiment.

It will be noted that throughout the appended drawings, like features are identified by like reference numerals.

### DETAILED DESCRIPTION

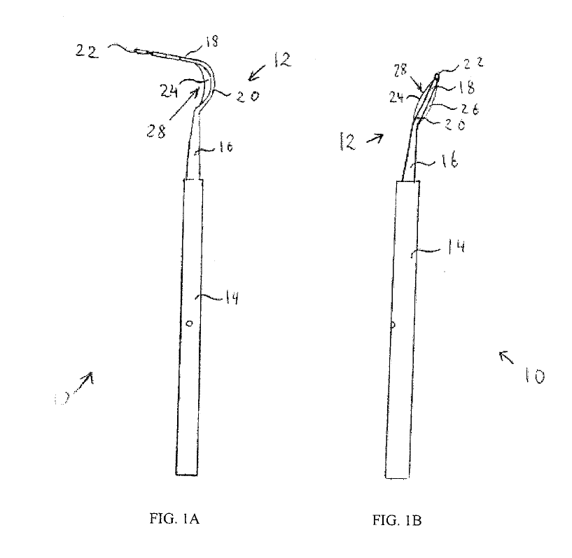

FIG. 1A illustrates one embodiment of a dental instrument 10 which comprises a probe portion 12 secured at one end of a handle 14. The probe portion 12 comprises three sections, namely a shaft 16 secured to one end of the handle 14, an explorer tip section 18, and a curved or hook-like curette section 20 therebetween.

The explorer tip section 18 is a cylindrical needle of which the external diameter varies along a length thereof, thereby dividing the explorer section 18 into successive segments of different external diameters. A probe ball 22 is provided at the remote tip end of the explorer section 18. While exploring a hole or cavity in a tooth, the probe ball 22 provides a visual indication of the depth of the hole or cavity. While exploring a periodontal pocket, the varying diameter segments of the explorer section 18 provide a visual indication of the depth of the periodontal pocket.

As illustrated in FIG. 1B which illustrates a side view of the dental instrument 10, the dental instrument 10 is curved such that the handle 14 and the shaft 16 of the probe section 12 are comprised in a first geometrical plane and the curved portion 20 and the explorer portion 18 are comprised in at least a second geometrical plane which intersects the first geometrical plane. This particular geometrical configuration makes the dental instrument suitable for accessing the lingual/buccal faces of teeth, for example.

The dental instrument 10 comprises two scraping members or fins 24 and 26 each protruding from opposite sides of the curved portion 20 of the dental instrument 10. The scraping fins 24 and 26 have a rigidity and shape adapted to remove biofilm and/or plaque deposited on a side of a tooth. In at least one embodiment, the scraping fins 24 and 26 are curved blades having one edge secured to the curved portion 20 and an opposite curved edge 28 which is exposed such as to allow access thereto. The curved edge 28 has a curvature (in the plane shown in FIG. 1A) which substantially corresponds to the curvature of a side of a tooth, such as the curvature of a free surface of a tooth.

In one embodiment, the curvature of the curved edge 28 corresponds to the curvature of the buccal or lingual face of a molar or a premolar.

In one embodiment, the curvature of the curved edge 28 substantially corresponds to the curvature of the buccal or labial surface of a tooth taken at the cervical third of the tooth. In another embodiment the curvature of the curved edge 28 substantially corresponds to the curvature of the lingual surface of an anterior tooth taken at the cervical third of the tooth. In a further embodiment, the curvature of the curved edge 28 substantially corresponds to the curvature of the side of a posterior tooth taken at the middle third of the lingual surface of the tooth. In another embodiment, the curvature of the curved edge 28 substantially corresponds to the curvature of the lingual surface of the lower second premolar taken at the occlusal third of the lingual surface.

In one embodiment, the curvature of the curved edge 28 substantially corresponds to the curvature of a side of a tooth along the length of the side of the tooth. In this case, the curved edge 28 may have any adequate length. For example, the length of the curved edge may be shorter or longer than the length of the side of the corresponding tooth. In another embodiment, the curvature of the curved edge 28 substantially corresponds to the curvature of a side of a tooth along the width of the side of the tooth. In this case, the curved edge 28 may have any adequate length. For example, the length of the curved edge may be shorter or longer than the width of the side of the corresponding tooth.

In one embodiment, the length of the curved edge is substantially equal to 8 mm. In another embodiment, the length of the curved edge 28 may substantially correspond to one third of the length or width of a tooth.

The curved edge 28 may have any adequate cross-section shape adapted to remove biofilm and/or plaque deposited on the surface of a tooth.

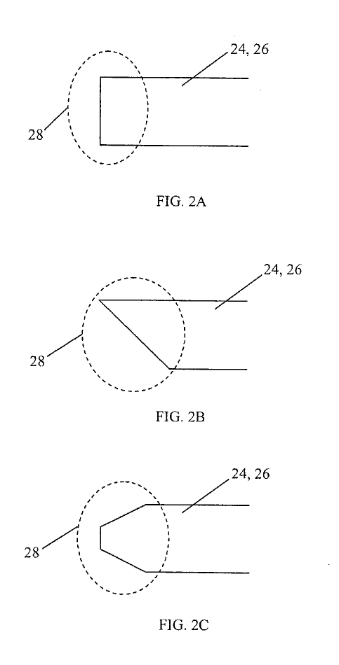

For example, the edge 28 may have a substantially square shape as illustrated in FIG. 2A, a bevel shape as illustrated in FIG. 2B, a trapezoidal shape as illustrated in FIG. 2C, etc.

In one embodiment, the curved edge 28 has a roughness adapted to remove the biofilm or plaque from the surface of a tooth. Alternatively, the curved edge may be substantially smooth. The curved edge can be made of any adequate material such as stainless steel for example.

In one embodiment, the scraping fins 24 and 26 are provided with substantially the same curvature. The curvature of the scraping edge 28 of the scraping fins 24 and 26 substantially corresponds to the curvature of a particular surface of a particular tooth. For example, the curvature of the scraping edge 28 may correspond to the curvature of the lingual surface of a particular molar. In another embodiment, the curvatures of the edges 28 of the scraping fins 24 and 26 are different. For example, the curvature of the edge 28 of the scraping fin 24 substantially corresponds to that of the lingual surface of a molar while the curvature of the edge 28 of the scraping fin 24 substantially corresponds to that of the labial surface of the molar.

While using the dental instrument 10 during a dental examination, a dentist or a technician may remove biofilm or plaque deposited on the teeth of a patient using the scraping fins 24 and 26. For example, the dentist wants to examine the labial surface of a particular molar and uses a dental instrument 10 of which the scraping fin 24 has a curvature substantially corresponding to that of the molar surface to be examined. The dentist abuts the scraping edge 28 of the scraping fin 24 against the molar surface to be examined and removes the biofilm or plaque deposited on the molar surface by upwardly and/or downwardly scraping the molar surface. Since the curvature of the edge 28 substantially corresponds to the curvature of the tooth surface, at least a part of the edge 28 of the scraping fin 24 is in physical contact with the surface of the molar during the scraping motion. This allows for the removal of the biofilm or plaque from at least a part of the molar surface. For example, the curved edge 28 may have a length adapted to remove biofilm or plaque located at the gingival margin.

While the dental instrument 10 is provided with two scraping fins 24 and 26 protruding from the curved curette section 20, it should be understood that the number and the location of the scraping fins may vary. For example, the dental instrument may be provided with a single scraping fin 24 protruding from the curved curette section 20. In another example, at least one scraping fin protrudes from the probe section 18.

While the dental instrument 10 is provided with an explorer section 18 comprising a probe ball 22 of the tip thereof, it should be understood that other explorer sections having different shapes may be used. For example, the explorer section 18 may be replaced by a tapered and pointed dental explorer.

The curved portion 20 of the instrument 10 may have any adequate shape. For example, the curved portion 20 may be substantially helical so that the dental instrument 10 corresponds to a cowhorn or pigtail explorer. The curved portion 20 may also be shaped and sized such that the dental instrument 10 has a shape similar to a curved shank explorer, an Orban No. 20 explorer, a sickle dental probe, a TU-17 explorer, or the like.

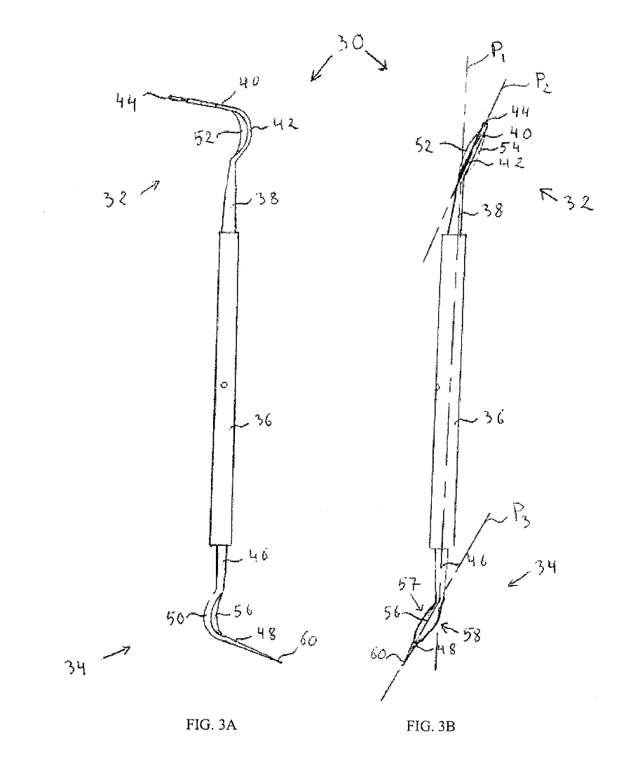

FIGS. 3A and 3B illustrates an embodiment of a probe instrument 30 which comprises two probe portions 32 and 34 secured to opposite ends of a handle 36. The probe portion 32 comprises three sections, namely a shaft 38 secured to the handle 36, a periodontal probe section 40, and a curved curette section 42 therebetween. The explorer section 40 is a cylindrical needle of which the external diameter varies along a length thereof, thereby dividing the explorer section 40 into successive segments of different external diameters. A probe ball 44 is secured at the end of the explorer section 40. The probe ball 44 can be used to provide a visual/tactile indication of the depth of a lesion in a tooth while the varying diameter segments of the explorer section 40 provide a visual indication of the depth of a periodontal pocket.

The second probe portion 34 comprises three sections, namely a shaft 46 secured to the handle 36, a dental explorer section 48, and a curved curette section 50 therebetween. The dental explorer section 48 is a tapered and pointed needle, adapted to examine surface activity of a tooth and/or remove dental plaque.

As illustrated in FIG. 3B, which illustrates a side view of the dental instrument 30, the probe portions 32 and 34 are curved such that the handle 36 and the shafts 38 and 46 are comprised in a first geometrical plane P₁, the curved portion 42 and the explorer portion 40 of the first probe section 32 are comprised in a second geometrical plane P₂, and the curved portion 50 and the dental explorer portion 48 of the first probe section 34 are comprised in a third geometrical plane P₃. The second and third geometrical planes P₂ and P₃ intersect the first geometrical plane P₁. This particular geometrical configuration makes the dental explorer 30 suitable for accessing the lingual faces of teeth, for example. While the second and third geometrical planes P₂ and P₃ are substantially parallel, it should be understood that other geometrical configurations are possible.

Two scraping fins 52 and 54 protrude from the curved curette section 42 of the first probe portion 32. Each scraping fin 52, 54 is provided with a curved edge having a curvature substantially corresponding to the curvature of a particular surface of a corresponding tooth. A curved scraping fin 56 is secured to the curved curette section 50 of the second probe portion 34. As illustrated in FIG. 3B, the scraping fin 56 is larger than the curved curette section 50 and is provided with two opposite curved edges 57 and 58. Each curved edge 57, 58 has a curvature which substantially corresponds to the curvature of a particular face of a corresponding tooth. For example, the curvature of the edges of each one of the scraping fins 52, 54, and 56 may substantially correspond to the curvature of the labial face of a particular molar. In one embodiment, one of the scraping fins 52, 54, and 56 and its respective curved edge are sized and shaped to be adapted to remove plaque, biofilm, and/or tartar from a molar. Another one of the scraping fins 52, 54, and 56 and its respective curved edge may be sized and shaped to be adapted to remove plaque, biofilm, and/or tartar from a premolar while the last one of the scraping fins 52, 54, and 56 and its respective curved edge may be sized and shaped to be adapted to remove plaque, biofilm, and/or tartar from an anterior smooth free surface of a specific tooth.

In another example, the curvature of the edge of the scraping fin 52 and the curvature of the edge 58 of the scraping fin 56 may substantially correspond to the curvature of the labial face of a particular molar while the curvature of the edge of the scraping fin 54 and the curvature of the edge 57 of the scraping fin 56 may substantially correspond to the curvature of the lingual face of the particular molar. In this example, while using the probe 30, a dentist or a technician may remove biofilm or plaque, remove light tartar, assess clinical lesion texture for activity or loss of substance and related depth for cavities, fissures, and the like, and examine gum pockets while using a single instrument, namely the dental instrument 30. The first probe portion 32 can be used to measure holes and cavities in a tooth for caries detection using the probe ball 44 and to measure the depth of gum pockets for periodontal examination. The pointed end 60 of the second probe portion 34 can be used for examining tactile initial sign of activity such as roughness in a tooth and/or for removing light tartar. In order to remove biofilm and/or plaque from the labial surface of a molar, the dentist uses the scraping fin 52 or the edge 58 of the scraping fin 56 and in order to remove biofilm and/or plaque from the lingual surface of the molar, the dentist uses the scraping fin 54 or the edge 57 of the scraping fin 56. Because the curvature of the scraping fin 52 and the curvature of the edge 58 of the scraping fin 56 substantially correspond to that of the labial ⅓ surface or more of the molar, at least a section of the curved edge of the scraping fin 52 and the edge 58 of the scraping fin 56 take the form of at least a section of the labial face of the molar when brought in physical contact with the labial face of the molar. This allows the scraping fins 52 and 56 to remove biofilm or plaque deposited of the labial face of the molar when upwardly and/or downwardly moved. Because the curvature of the scraping fin 54 and the curvature of the edge 57 of the scraping fin 56 substantially correspond to that of the lingual surface of the molar, at least a section of the curved edge of the scraping fin 54 and the edge 57 of the scraping fin 56 takes the form of at least a section of the lingual face of the molar when brought in physical contact with the lingual face of the molar. This allows the scraping fins 54 and 56 to remove biofilm or plaque deposited of the labial face of the molar when upwardly and/or downwardly moved.

While the curved curette portions 42 and 50 substantially have the same shape, it should be understood that they can be provided with different shapes and/or radii of curvature. For example, the curved curette portion 42, 50 may be substantially helical.

In one embodiment, the section 18, 40, 48 has a length of about 1.5 cm.

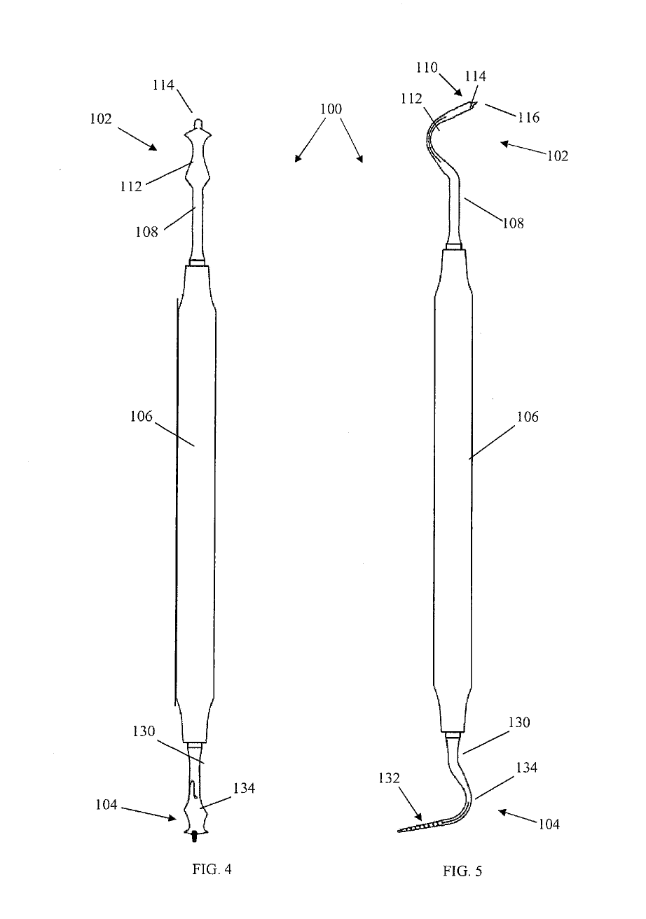

FIGS. 4 and 5 illustrate a further embodiment of a hand-held dental instrument 100 for detection of carious lesions. The dental instrument comprises two workings ends, namely a dental explorer end 102 and a periodontal probe end 104 extending from opposite ends of a handle 106 adapted to be grasped by a hand of a user. The dental explorer end 102 is used for exploring the surface of a tooth, i.e. for determining the presence of tooth decay on the enamel of a tooth. The periodontal probe end 104 is used at least for exploring periodontal pockets, i.e. for to measuring pocket depths around a tooth in order to establish the state of health of the periodontium. In some embodiments, the periodontal probe end 104 may also be used for exploring the surface of a tooth.

As illustrated in FIG. 5, the dental explorer end 102 comprises two sections, i.e. a probe body comprising a shaft 108 secured to and extending from the handle 106 and a curved curette section 112, and a probe tip extending from the curette section 112 and corresponding to a dental explorer tip 110. At least a section of the probe body is curved in a first plane substantially parallel to the longitudinal axis of the handle 106. The dental explorer tip 110 comprises a cylindrical section 114 having a substantially constant diameter along a length thereof, and a sharp point 116 extending from the cylindrical section 114. The largest diameter of the point 116 is less than the diameter of the cylindrical section 114. The difference of diameter between the cylindrical section 114 and the point 116 limits the penetration depth of the dental explorer tip 110 substantially to the length of the sharp point 116.

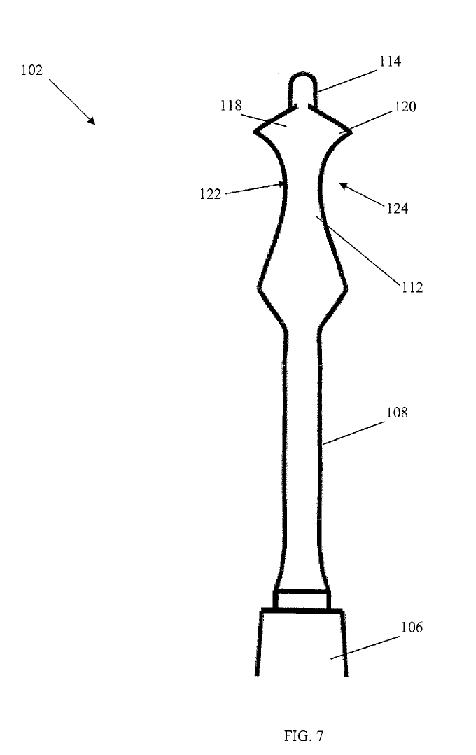

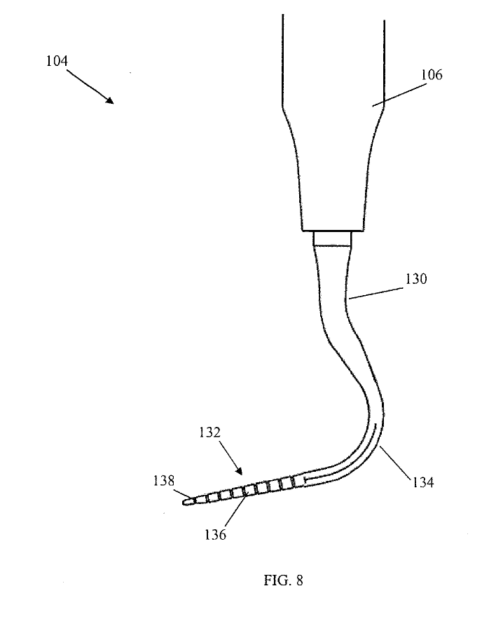

As illustrated in FIGS. 4 and 7, the curved curette section 112 of the dental explorer end 102 comprises two scraping fins or fins 118 and 120 projecting radially therefrom in substantially opposite directions. The scraping fins 118 and 120 each lies in a respective plane substantially perpendicular to the first plane. The scraping fins 118 and 120 each define a curved blade and have one edge secured to the curved curette section 112 and an opposite curved edge 122 and 124, respectively, which is exposed such as to allow access thereto. The curved edge 122, 124 has a curvature which substantially corresponds to the curvature of a side or surface of a tooth. While in the present embodiment, they are symmetrical, it should be understood that the scraping fins 118 and 120 can be provided with a different width, length and/or edge curvature.

While the width “w” of the scraping fins 118 and 120 first decreases and then increases along the curette section 112 from the handle 106 towards the dental explorer tip 110, thereby defining a concave edge relative to the second plane, it should be understood that other configurations may be possible. For example, the width w of the scraping fins 118 and 120 may continuously decrease along the curette section 112 from the handle 106 towards the dental explorer tip 110, thereby defining a curved edge. In another example, the width w of the scraping fins 118 and 120 continuously may increase along the curette section 112 from the handle 106 towards the dental explorer tip 110 to define the curved edge.

While they can be made from different pieces and fixedly secured together using any adequate securing means such as adhesive, welding, etc, it should be understood that the shaft 108, the dental explorer tip 110, and the curved curette section 112 comprising the scraping fins 118 and 120 can be integral to form a single piece.

The scraping fins 118 and 120 can be provided with any adequate dimensions. For example, the curvature radius of the curved edges 122 and 124 can be comprised between about 6 mm and about 7 mm, and the length l of the curved edges 122 and 124 can be comprised between about 9 mm and about 10 mm.

As illustrated in FIGS. 5 and 8, the periodontal probe end 104 comprises two sections, i.e. a probe body comprising a shaft 130 secured to and extending from the handle 106 and a curved curette section 134, and a probe tip extending from the curved curette section 134 and corresponding to a periodontal probe tip 132. The probe body being curved in the first plane substantially parallel to the longitudinal axis of the handle 106. It should be understood that the handle 106 may be curved so that the probe body of the dental explorer end 102 and the probe body of the periodontal probe may be curved in different parallel planes.

The periodontal probe tip 132 is a tapered cylindrical needle of which the external diameter varies along a length thereof, thereby dividing the periodontal probe tip 132 into successive segments 136 of different external diameters and defining successive rings along the periodontal probe tip 132. Each segment 136 of the periodontal probe tip 132 has a predetermined length so that the varying diameter segments 136 provide a visual indication of the depth of the periodontal pocket when the periodontal probe tip 132 is inserted therein. It should be understood that the periodontal probe tip 132 may be provided with any adequate markings allowing a user to assess the deepness of a periodontal pocket. For example, the diameter of the periodontal probe tip 132 may be substantially constant along the length thereof and successive segments of different colors may create markings along the periodontal probe tip 132.

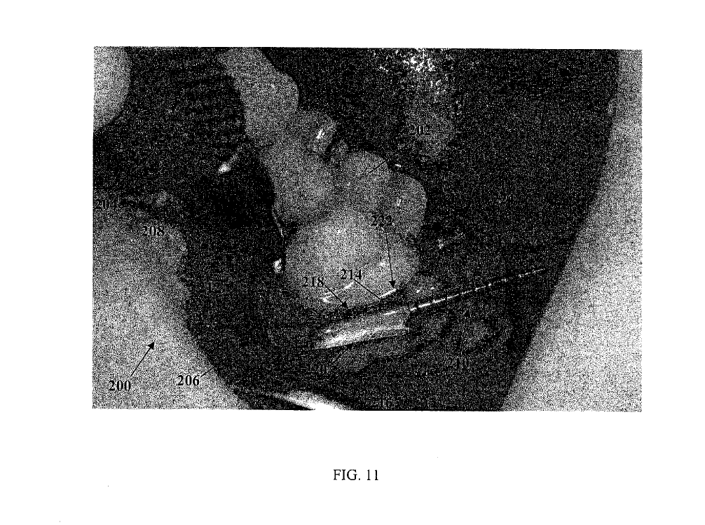

As illustrated in FIG. 10, a probe cylinder 138 is provided at the remote tip end of the periodontal probe tip 132. While exploring a tooth surface, the probe cylinder 138 allows for dental lesion detection and provides a visual indication of the depth of a hole or cavity in a tooth surface. It should be understood that the probe cylinder 138 may be replaced by a probe ball as described above or any other probe element having any adequate shape for detecting dental lesions on a tooth surface. Alternatively, the periodontal probe tip 132 may comprise no probe element at its remote end. In this case, the remote end of the periodontal probe tip 132 may be rounded to facilitate the insertion of the periodontal probe tip 132 into periodontal pockets.

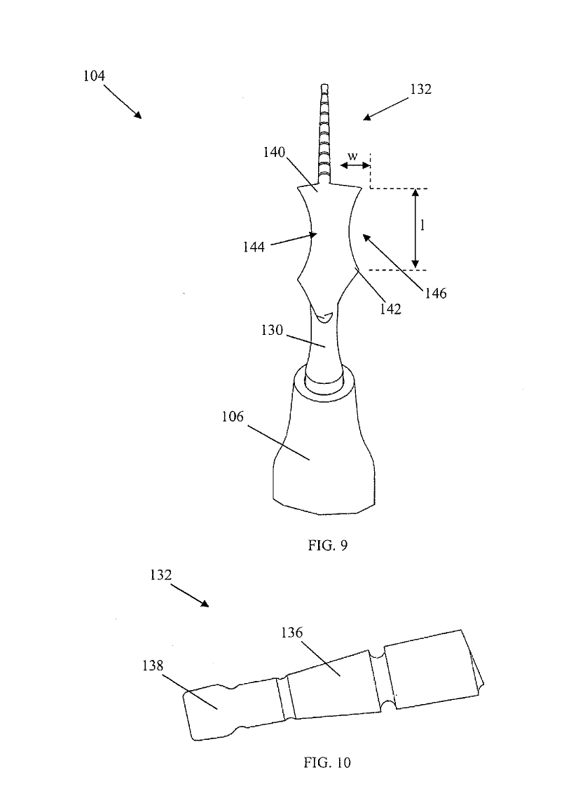

As illustrated in FIGS. 4 and 9, the curved curette section 134 of the periodontal probe end 104 comprises two scraping fins 140 and 142 radially projecting therefrom in substantially opposite directions. The scraping fins 140 and 142 lie in a plane substantially perpendicular to the curvature plane of the curette section 134. The scraping fins 140 and 142 each define a curved blade and have one edge secured to the curved curette section 134 and an opposite curved edge 144 and 146, respectively, which is exposed such as to allow access thereto. The curved edges 144 and 146 each have a curvature which substantially corresponds to the curvature of a side or surface of a tooth. The curvature radius of the edges 114 and 146 are identical together and substantially equal to that of the edges 122 and 124 of the dental explorer end 102.

While the scraping fins 118 and 120 of the dental explorer end 102 are symmetrical, the scraping fins 140 and 142 of the periodontal probe end 104 are provided with a different length l and a different width w. It should be understood that other configurations may be possible. For example, each scraping fin 118, 120, 140, and 142 may have dimensions specific to a particular tooth, a particular tooth surface, and/or the like. For example, the scraping fins 118 and 120 may have dimensions adequate for a molar and a premolar, respectively, while the scraping fins 140 and 142 may have adequate dimensions for a canine and an incisor, respectively.

In one embodiment, the length of the scraping edge 146 is comprised between about 6 mm and about 7 mm while the length of the scraping member 144 is comprised between about 7 and 8 mm. In one embodiment, the curvature radius of the edges 122, 124, 144, and 146 is constant along a length thereof and substantially equal to about 5 mm.

While in the embodiment illustrated in FIGS. 4 and 5, the edges 122, 124, 144, and 146 are all provided with substantially the same curvature radius, it should be understood that other configurations are possible. For example, each edge 122, 124, 144, and 146 may have a curvature radius specific to a particular tooth, a particular tooth surface, and/or the like, as described above. For example, the edges 122 and 124 may have a curvature substantially corresponding to the curvature of the lingual face and the facial face of a molar, respectively, while the edges 144 and 146 may have a curvature substantially corresponding to the curvature of the lingual face and the facial face of a premolar, respectively.

In one embodiment, the curved edges 122, 124, 144, and 146 are beveled so that the scraping fins 118, 120, 140, and 142 may be used as blades for removing biofilm, plaque, tartar, and/or the like accumulated on the surface of a tooth. It should be understood that the curved edges can be provided with any other adequate cross-sectional shape as illustrated in FIGS. 2a-2c.

While they can be made from different pieces and fixedly secured together using any adequate securing means such as adhesive, it should be understood that the shaft 130, the dental explorer tip 132, and the curved curette section 134 comprising the scraping fins 140 and 142 can be integral to form a single piece.

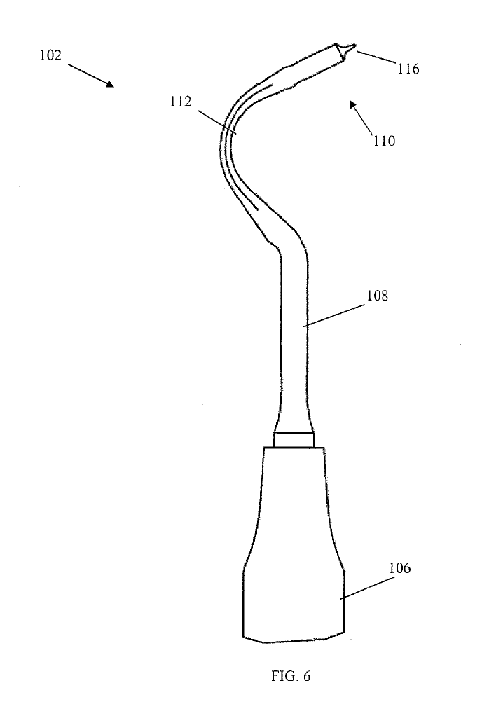

While in the embodiment illustrated in FIGS. 4, 5, 6, and 8, they have a Shepherd's hook shape, the dental explorer end 102 and the periodontal probe end 104 may be provided with any other adequate shape, as described above. For example, the dental explorer end 102 and the periodontal probe end 104 can be shaped to correspond to a cowhorn or pigtail explorer.

The skilled person will understand that the dental instrument 100 may be provided with a single probe portion, i.e. the dental explorer end 102 or the periodontal probe end 104 may be omitted.

While they extend on opposite sides with respect to the axis of the handle 106 as illustrated in FIG. 5, the skilled person will recognize that the dental explorer tip 110 and the periodontal probe tip 134 may be located on the same side of the handle 106.

FIG. 11 is a photograph illustrating the use of a dental instrument 200 for removing plaque, biofilm, and/or tartar deposited on the enamel of a molar 202. The dental instrument 200 comprises a handle 204 and a periodontal probe end 206 extending at one end of the handle 204. The periodontal probe end 206 comprises three sections, i.e. a shaft 208 secured to and extending from the handle 204, a periodontal probe tip 210, and a curved curette section 212 therebetween. The periodontal probe tip 210 is a tapered cylindrical needle of which the external diameter varies along a length thereof, thereby dividing the periodontal probe tip 132 into successive segments or rings of different external diameters for assessing the deepness of periodontal pockets.

The curved curette section 212 of the periodontal probe end 206 comprises two scraping fins 214 and 216 projecting therefrom in substantially opposite directions with respect to the plane comprising the axes of handle 204 and periodontal probe tip 210. The scraping fins 214 and 216 each have one edge secured to the curved curette section 212 and an opposite curved edge 218 and 220, respectively, which is exposed such as to allow access thereto.

The curved edge 218 of the scraping fin 214 has a curvature which substantially corresponds to the curvature of a facial surface of the molar 202 so that at least a section of the scraping edge 218 engages a section of the facial surface of the molar 202 when the user abuts the scraping fin 214 against the facial surface of the molar 202. Similarly, the curved edge 220 of the scraping fin 216 has a curvature which substantially corresponds to the curvature of a lingual surface of the molar 202 so that at least a section of the scraping edge 220 engages a section of the lingual surface of the molar 202 when the user abuts the scraping fin 216 against the lingual surface of the molar 202

In order to remove biofilm, plaque, and/or tartar deposited on the facial surface of the molar 202, a user scrapes the facial surface using the central section of the scraping edge 218. Since the curvature of scraping edge 218 corresponds to that of the facial surface of the molar 202, the central section of the scraping edge 218 is in physical contact with at least a section of the facial surface of the molar 202. By upwardly and/or downwardly moving the scraping fin 214, the biofilm, plaque, and/or tartar can be removed from the facial surface of the molar. Similarly, the user scrapes the lingual surface of the molar 202 using the central section of the scraping edge 220 in order to remove biofilm, plaque, and/or tartar deposited on the lingual surface. Since the curvature of scraping edge 220 corresponds to that of the lingual surface of the molar 202, the central section of the scraping edge 220 is in physical contact with at least a section of the lingual surface of the molar 202. By upwardly and/or downwardly moving the scraping fin 216, the biofilm, plaque, and/or tartar can be removed from the lingual surface of the molar 202.

As illustrated in FIG. 11, the extremity 222 of the scraping edge 218 can be used for removing biofilm, plaque, and/or tartar from the distal surface of the molar 202. Since it is substantially sharp, the extremity 222 of scraping edge 218 can penetrate between the molar 202 and the adjacent molar 224 and abuts against the distal surface of the molar 202. By upwardly and/or downwardly moving the scraping fin 216, the biofilm, plaque, and/or tartar can be removed from at least a portion of the distal surface of the molar 202. Similarly, the opposite extremity of the scraping edge 218 can be used for removing biofilm, plaque, and/or tartar from the mesial surface of the molar 202.

While the present description refers to scraping edges 18, 58, 122, 124, 144, 146, 218, 220 having a curvature constant along a length thereof, it should be understood that the curvature radius of the scraping edge may vary along the length thereof. For example, the curvature radius of the extremities of the scraping edge may be less than that of the central section of the scraping edge to facilitate access to the extremities to the distal and/or mesial surface of a tooth.

It should also be understood that the number and the location of the scraping fins 52, 54, 56, 58, 118, 120, 140, 142, 214, and 216 may vary as long as the dental instrument 12, 30, 100, 200 comprises at least one scraping fin adapted to remove biofilm and/or plaque and/or tartar deposited on a tooth surface.

While the present description refers to a dentist or a technician as user of the dental instrument 10, 30, 100, 200, it should be understood that the dental instrument 10, 30, 100, 200 is not restricted to professionals and that it can be used by any users.

While the dental instruments 10, 30, 100, 200 are provided with a probe portion 12, 30, 34, 102, 104, 206 comprising a curved curette section 20, 42, 50, 112, 134, 212 it should be understood that the curved curette section 20, 42, 50, 112, 134, 212 may be omitted such that the probe tip is secured to the shaft. In this case, the scraping members may project from the probe tip or the shaft.

It should be understood that the curette section 20, 42, 50, 112, 134, 212 may have any adequate shape such as a helical shape for example. While the present description refers to curved curette sections 20, 42, 50, 112, 134, 212, it should be understood that the curette sections may be linear.

It should be understood that the shaft 16, 38, 46, 108, 130, 208 may be omitted. In this case, the curette portion is directly mounted to the handle.

The embodiments of the present disclosure described above are intended to be examples only. Those of skill in the art may effect alterations, modifications and variations to the particular example embodiments without departing from the intended scope of the present disclosure. In particular, selected features from one or more of the above-described example embodiments may be combined to create alternative example embodiments not explicitly described, features suitable for such combinations being readily apparent to persons skilled in the art. The subject matter described herein in the recited claims intends to cover and embrace all suitable changes in technology.

1. A hand-held dental instrument for detection of carious lesions comprising:
a handle portion adapted to be grasped by a hand of a user and defining a longitudinal axis extending axially therethrough; and
at least a first working end mounted on the handle portion, the first working end including a probe body extending from the handle portion and a probe tip disposed at a remote end of the probe body, the probe tip being configured for exploring at least one of teeth and periodontal pockets, the probe body being curved and defining a curette portion thereon between the handle portion and the probe tip, the curette portion having one scraping fin projecting from the probe body, the scraping fin defining a curved blade for removing at least one of biofilm, plaque and tartar from a curved tooth surface.

2. The hand-held dental instrument as claimed in claim 31, wherein each scraping fin has a width varying along a length thereof to define a curved edge for the scraping fin.

3. The hand-held dental instrument as claimed in claim 2, wherein the width first decreases and then increases along the length of the scraping fin from the handle portion towards the probe tip.

4. The hand-held dental instrument as claimed in claim 1, wherein the curved blade has a curvature which substantially corresponds to that of the curved tooth surface.

5. The hand-held dental instrument as claimed in claim 1, wherein the probe body is curved relative to a first plane that is substantially parallel to the longitudinal axis.

6. The hand-held dental instrument as claimed in claim 5, wherein the scraping fin is at least partially disposed in a second plane substantially perpendicular to the first plane.

7. The hand-held dental instrument as claimed in claim 6, wherein the scraping fin is concave relative to the second plane.

8. The hand-held dental instrument as claimed in claim 4, wherein the curvature of the curved blade is configured to correspond to a width of the curved tooth surface.

9. The hand-held dental instrument as claimed in claim 4, wherein the curvature of the curved blade is configured to correspond to a height of the curved tooth surface.

10. The hand-held dental instrument as claimed in claim 1, wherein the curved tooth surface is one of a buccal surface and a facial surface of a tooth.

11. The handheld dental instrument as claimed in claim 10, wherein the tooth is at least one of molar and a premolar.

12. The hand-held dental instrument as claimed in claim 31, wherein the curvature of the curved blade is substantially identical for the at least two scraping fins.

13. The hand-held dental instrument as claimed in claim 1, wherein the scraping fin has at least one beveled edge.

14. The hand-held dental instrument as claimed in claim 13, wherein the probe body has a Shepherd's hook shape.

15. The hand-held dental instrument as claimed in claim 1, wherein the probe tip is a periodontal probe tip comprising an elongated needle extending from the probe body and having a plurality of depth markings along a length thereof for depth assessment of the periodontal pockets.

16. The hand-held dental instrument as claimed in claim 15, wherein the probe tip further comprises a probe element secured at a distal end thereof for determining a presence of tooth decay on the tooth surface.

17. The hand-held dental instrument as claimed in claim 16, wherein the probe element is one of a probe ball and a probe cylinder.

18. The hand-held dental instrument as claimed in claim 15, wherein the elongated needle has an external diameter varying along the length thereof to define the plurality of markings.

19. The hand-held dental instrument as claimed in claim 1, wherein the probe tip comprises a dental explorer tip having a tapered and sharp end for determining a presence of tooth decay on the curved tooth surface.

20. The hand-held dental instrument as claimed in claim 19, wherein the probe tip comprises a stop element for limiting a penetration depth of the probe tip in the tooth decay.

21. The hand-held dental instrument as defined in claim 1, further comprising a second working end mounted on the handle portion, the second working end including a second probe body extending from the handle portion and a second probe tip disposed at a remote end of the second probe body, the second probe tip being configured for exploring the other one of the at least one of the teeth and the periodontal pockets, the second probe body being curved and defining a second curette portion disposed on the second probe body between the handle portion and the second probe tip, the second curette portion having a second scraping fin projecting from the second probe body, the second scraping fin defining a second curved blade for removing the at least one of biofilm, plaque, and tartar from the curved tooth surface.

22. The hand-held dental instrument as defined in claim 21, wherein the second probe body is curved relative to a third plane substantially parallel to said longitudinal axis.

23. The hand-held dental instrument as defined in claim 22, wherein the second scraping fin is at least partially disposed in a fourth plane substantially perpendicular to the third plane.

24. The hand-held dental instrument as claimed 22, wherein the first plane and the third plane are identical.

25. The hand-held dental instrument as claimed 24, wherein the probe tip of the first working end and the second probe tip of the second working end are located on opposite sides with respect to a plane comprising the longitudinal axis of the handle portion and perpendicular to the first and third planes.

26. The hand-held dental instrument as claimed in claim 21, wherein the second curved blade has a curvature which substantially corresponds to that of the curved tooth surface.

27. The hand-held dental instrument as claimed in claim 22, wherein the probe tip of the first working end is a dental explorer and the second probe tip of the second working end is a periodontal probe.

28. A hand-held dental instrument for detection of carious lesions and including a handle portion defining a longitudinal axis therethrough, the hand-held dental instrument comprising:
a first working end mounted on the handle portion at one end thereof, the first working end including a first probe body extending from the handle portion and a sharp dental explorer tip disposed at a remote end of the first probe body, the sharp dental explorer tip being configured for determining a presence of tooth decay on a tooth surface, and a first curette portion disposed on the first probe body between the handle portion and the sharp dental explorer tip; and
a second working end mounted on the handle portion at another end thereof, the second working end including a second probe body extending from the handle portion and a periodontal explorer tip disposed at a remote end of the second probe body, the periodontal explorer tip being configured for exploring periodontal pockets, and a second curette portion disposed on the second probe body between the handle portion and the periodontal probe tip.

29. The hand-held dental instrument as defined in claim 28, wherein the first and second probe bodies are curved relative to a first plane substantially parallel to said longitudinal axis, and the first and second curette portions each having at least two opposed scraping fins projecting radially from the first probe body and the second probe body, respectively, the scraping fins each defining a curved blade for removing at least one of biofilm, plaque and tartar from a curved tooth surface.

30. The hand-held dental instrument as defined in claim 28, wherein the scraping fins for the first and second probe bodies are at least partially disposed in a respective second plane substantially perpendicular to the first plane.

31. The hand-held dental instruction as claimed in claim 1, wherein the curette portion includes at least two of said scraping fins projecting radially from the probe body in opposite directions.

32. The hand-held dental instrument as defined in claim 21, wherein the second curette portion includes at least two of said second scraping fins projecting radially from the probe body in opposite directions.
